(19) United States
(12) Patent Application Publication
(10) Pub. No.: US 2026/0093481 A1
(43) Pub. Date: Apr. 2, 2026

(54) MANAGING SOFTWARE ARTIFACT SNAPSHOT REPOSITORIES USING DEFINITION FILES

(71) Applicant: Dell Products L.P., Round Rock, TX (US)

(72) Inventors: George Kraft, IV, Wichita Falls, TX (US); Benjamin J. Pitzer, Morrisville, NC (US); Robert A. Ballantyne, Mansfield, MA (US); Mathew Comeau, Warren, MA (US)

(21) Appl. No.: 18/898,881

(22) Filed: Sep. 27, 2024

(51) Int. Cl. G06F 8/71; G06F 8/65; G06F 16/11

(52) U.S. Cl. CPC G06F 8/71; G06F 8/65; G06F 16/128

(57) ABSTRACT

Techniques are provided for managing software artifact snapshot repositories using definition files. One method comprises obtaining a definition file for a software artifact snapshot repository to be created in association with a given software application, wherein the definition file comprises information characterizing software artifacts used by the given software application to be included in the software artifact snapshot repository; and creating the software artifact snapshot repository, using the definition file, with the one or more software artifacts, wherein a software build of the given software application obtains at least some of the software artifacts using the created software artifact snapshot repository. At least some of the software artifacts included in the software artifact snapshot repository may be automatically updated in response to determining that a content of the software artifact snapshot repository does not match a current version of the definition file.

### BACKGROUND

A software deployment pipeline automates a software delivery process, and typically comprises a set of automated processes and tools that allow software developers and an operations team to work together to generate and deploy application software code to a production environment using a software development platform. Software development tasks often employ a software build process to compile the generated software code.

### SUMMARY

Illustrative embodiments of the disclosure provide techniques for managing software artifact snapshot repositories using definition files. An exemplary method comprises obtaining a definition file for a software artifact snapshot repository to be created in association with a given software application, wherein the definition file comprises information characterizing one or more software artifacts used by the given software application to be included in the software artifact snapshot repository; and creating the software artifact snapshot repository, using the definition file, with the one or more software artifacts, wherein a software build of the given software application obtains one or more of the software artifacts using the created software artifact snapshot repository.

Illustrative embodiments can provide significant advantages relative to conventional techniques. For example, technical problems associated with maintaining the integrity and/or static content associated with a software application are mitigated in one or more embodiments by employing software artifact snapshot repositories that are created using one or more corresponding definition files to include one or more designated software artifacts.

Other illustrative embodiments include, without limitation, apparatus, systems, methods and computer program products comprising processor-readable storage media.

### BRIEF DESCRIPTION OF THE DRAWINGS

FIG. 1 illustrates an information processing system configured for managing software artifact snapshot repositories using definition files, in accordance with an illustrative embodiment;

FIG. 2 shows an example of a software development lifecycle in an illustrative embodiment;

FIG. 3 shows an example of at least portions of the software development lifecycle of FIG. 2 in further detail, in accordance with an illustrative embodiment;

FIG. 4 illustrates a representative definition file for a software artifact snapshot repository associated with a given software application, in accordance with an illustrative embodiment;

FIG. 5 is a flow chart illustrating an exemplary processing of git-based pull requests and an initiation of a creation of a software artifact snapshot repository, in accordance with an illustrative embodiment;

FIG. 6 illustrates a management job for processing updates to a definition file for a software artifact snapshot repository, in accordance with an illustrative embodiment;

FIG. 7 illustrates a management job for validating definition files for software artifact snapshot repositories over time, in accordance with an illustrative embodiment;

FIG. 8 is a flow diagram illustrating an exemplary implementation of a process for managing software artifact snapshot repositories using definition files, in accordance with illustrative embodiments;

FIG. 9 illustrates an exemplary processing platform that may be used to implement at least a portion of one or more embodiments of the disclosure comprising a cloud infrastructure; and

FIG. 10 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for managing software artifact snapshot repositories using definition files.

The term DevOps generally refers to a set of practices that combines software development and information technology (IT) operations. DevOps are increasingly being used to shorten the software development lifecycle and to provide continuous integration, continuous delivery, and continuous deployment. Continuous integration (CI) generally allows development teams to merge and verify changes more often by automating software generation (e.g., converting source code files into standalone software components that can be executed on a computing device) and software tests, so that errors can be detected and resolved early. Continuous delivery extends continuous integration and includes efficiently and safely deploying the changes into testing and production environments. Continuous deployment (CD) allows code changes that pass an automated testing phase to be automatically released into the production environment, thus making the changes visible to end users. Such processes are typically executed within a software generation and deployment pipeline.

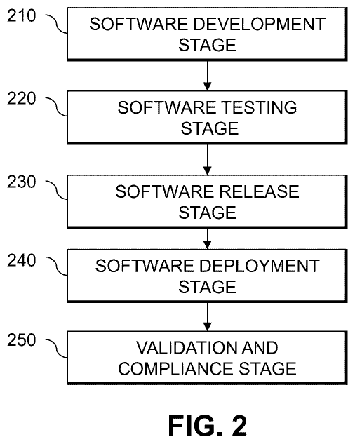

DevOps solutions typically employ blueprints that encompass continuous integration, continuous testing (CT), continuous deployment (also referred to as continuous development) and/or continuous change and management (CCM) abilities. DevOps blueprints allow development teams to efficiently innovate by automating workflows for a software development and delivery lifecycle. A typical software development lifecycle is discussed further below in conjunction with FIG. 2.

A software deployment pipeline (sometimes referred to as a CI/CD pipeline) automates a software delivery process, and typically comprises a set of automated processes and tools that allow developers and an operations team to work together to generate and deploy application software code to a production environment. A preconfigured software deployment pipeline may comprise a specified set of elements and/or environments. Such elements and/or environments may be added or removed from the software deployment pipeline, for example, based at least in part on the software and/or compliance requirements. A software deployment pipeline typically comprises one or more quality control gates to ensure that software code does not get released to a production environment without satisfying a number of predefined testing and/or quality requirements. For example, a quality control gate may specify that software code should compile without errors and that all unit tests and functional user interface tests must pass.

As noted above, it may be desirable to retain a static representation of software artifacts associated with the software build process as a static software artifact snapshot. Such a software artifact snapshot enables a software build process to be reproducible, ensuring the continuity of a software build process of a given software release. In one or more embodiments, the disclosed techniques for managing software artifact snapshot repositories using definition files provide software artifact snapshot repositories that maintain the integrity and static content of software build dependency artifact repositories using a centrally managed set of tools surrounding a specific collection of configuration definitions. The disclosed software artifact snapshot repository management techniques enable static software dependency content creation and allow for the archival of a content of a software artifact repository to ensure that the content can be retrieved to reproduce a given software build at any time.

There is typically a set of dependency content required to complete a given software build (e.g., to set up the build environment and/or provide the supporting software). Subsequent builds of the same software product, such as in terms of sub-versions of a given code branch, must use the same content, or specifically change dependency artifacts for such software code and/or the environment in which the software code is built. Software build dependencies typically resolve to the latest versions, which may include one version of a dependency when a given software products ships, but can resolve to a different version at some later time. The reproducibility of a given software build, with only expected changes to the resultant binary artifacts, is an important factor for producing consistent software releases, and for creating software patch releases with the required changes to avoid introducing new bugs, vulnerabilities and/or regressions.

Software builds should also be reproducible when trying to maintain a minimal storage footprint, where content that is less utilized can be either archived or deleted entirely, depending on factors including risk and the ability to recreate the content. A time to reproduce the software build is also a factor.

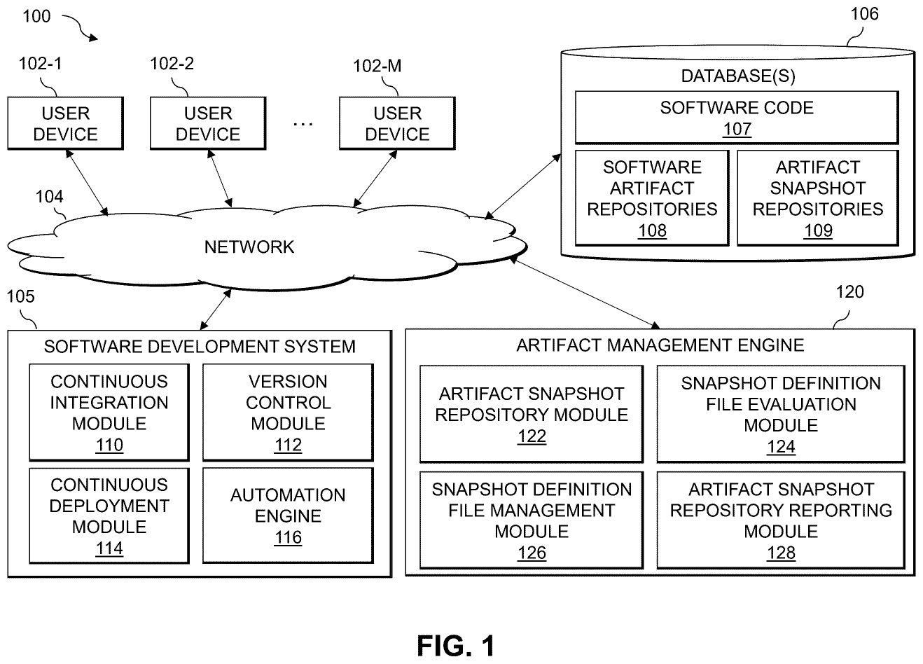

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 may be employed, for example, by software developers and other DevOps professionals to perform, for example, software development and/or software deployment tasks. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a software development system 105 and an artifact management engine 120.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

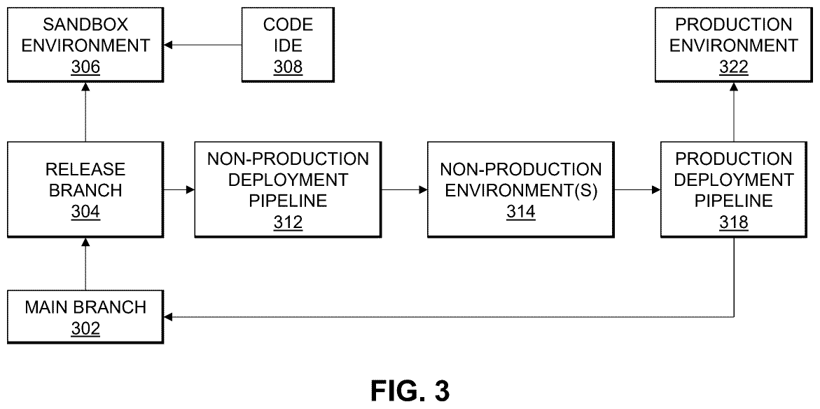

The software development system 105 comprises a continuous integration module 110, a version control module 112, a continuous deployment module 114 and an automation engine 116. Exemplary processes utilizing elements 110, 112, 114 and/or 116 will be described in more detail with reference to, for example, the flow diagrams of FIGS. 2 and 3.

In at least some embodiments, the continuous integration module 110, the version control module 112 and/or the continuous deployment module 114, or portions thereof, may be implemented using functionality provided, for example, by commercially available DevOps and/or CI/CD tools, such as a Git-based DevOps and/or CI/CD tool. The continuous integration module 110, the version control module 112 and the continuous deployment module 114 may be configured, for example, to perform CI/CD tasks and to provide access to DevOps tools and/or repositories. The continuous integration module 110 provides functionality for automating the integration of software code changes from multiple software developers or other DevOps professionals into a single software project.

In one or more embodiments, the version control module 112 manages canonical schemas (e.g., blueprints, job templates, and software scripts for jobs) and other aspects of the repository composition available from the DevOps and/or CI/CD tool. SCM techniques may be used to track modifications to a source code repository. In some embodiments, SCM techniques are employed to track a history of changes to a software code base and to resolve conflicts when merging updates from multiple software developers. Such SCM techniques provide a definitive repository from which source code, orchestration code, test code and configuration information may be obtained.

The continuous deployment module 114 manages the automatic release of software code changes made by one or more software developers from a software repository to a production environment, for example, after validating the stages of production have been completed. The continuous deployment module 114 may interact in some embodiments with the automation engine 116 to resolve one or more errors in a software deployment pipeline and/or to verify a successful testing of a software deployment pipeline.

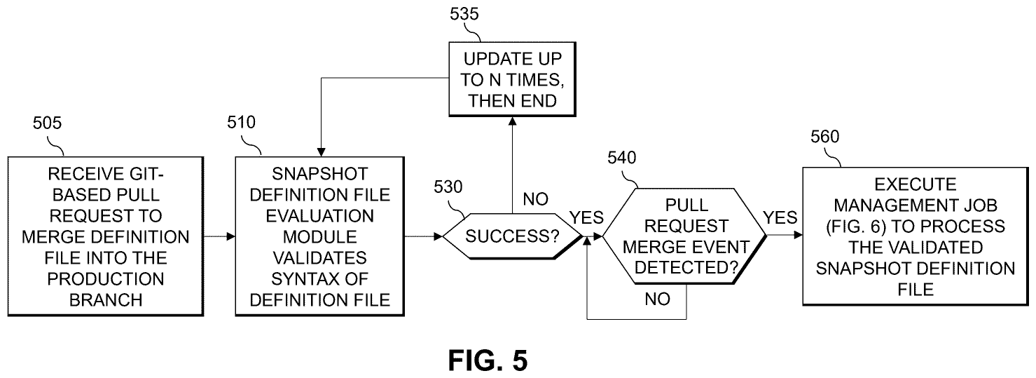

In at least some embodiments, the automation engine 116 may implement at least portions of the disclosed techniques for managing software artifact snapshot repositories using definition files, as discussed further below in conjunction with, for example, FIG. 5.

It is to be appreciated that this particular arrangement of elements 110, 112, 114 and/or 116 illustrated in the software development system 105 of the FIG. 1 embodiment is presented by way of example only, and alternative arrangements can be used in other embodiments. For example, the functionality associated with the elements 110, 112, 114 and/or 116 in other embodiments can be combined into a single module, or separated across a larger number of modules. As another example, multiple distinct processors can be used to implement different ones of the elements 110, 112, 114 and/or 116 or portions thereof.

At least portions of elements 110, 112, 114 and/or 116 may be implemented at least in part in the form of software that is stored in memory and executed by a processor.

In at least some embodiments, the artifact management engine 120 may contain the required files for defined static repositories or have the capability to obtain the same version of a required file. In this manner, the artifact management engine 120 can provide the relevant version of each software artifact at a given point in time and manages a static software artifact setup (e.g., without worrying about software content being expired or removed).

In the example of FIG. 1, the artifact management engine 120 comprises an artifact snapshot repository module 122, a snapshot definition file evaluation module 124, a snapshot definition file management module 126 and an artifact snapshot repository reporting module 128. Exemplary processes utilizing elements 122, 124, 126 and/or 128 will be described in more detail with reference to, for example, the flow diagrams of FIGS. 5 through 8.

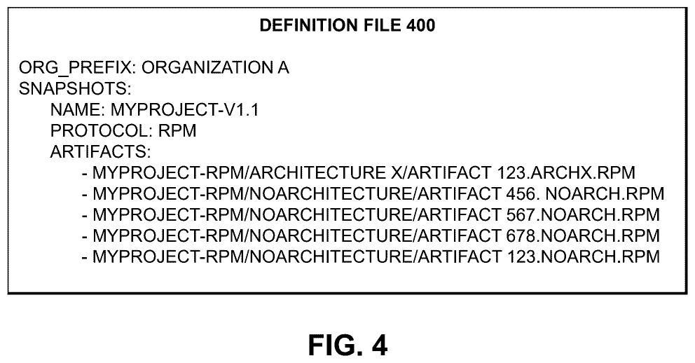

In at least some embodiments, the artifact snapshot repository module 122 creates software artifact snapshot repositories in accordance with definition files for the software artifact snapshot repository, as discussed further below in conjunction with FIG. 4. A software artifact snapshot repository, in one or more embodiments, is a repository generated for the purpose of being a snapshot.

In at least one embodiment, the snapshot definition file evaluation module 124 may validate the syntax of a definition file and report on any errors for each pull request, as discussed further below in conjunction with FIG. 5.

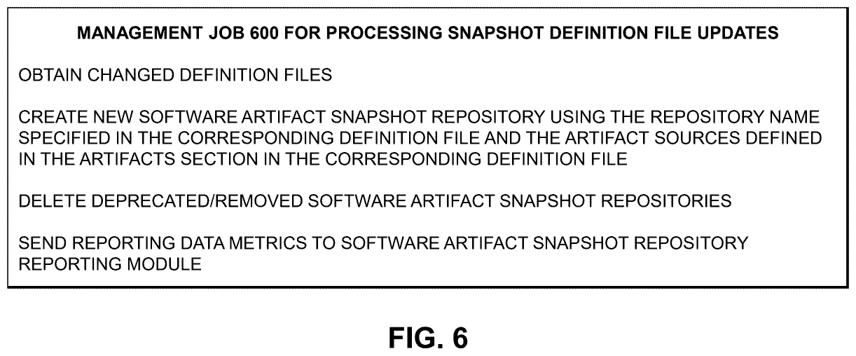

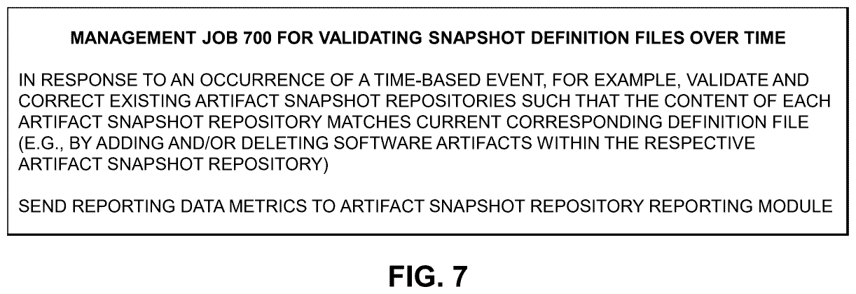

In at least some embodiments, the snapshot definition file management module 126 executes one or more management jobs, as discussed further below in conjunction with FIGS. 6 and 7, that create new software artifact snapshot repositories using the specified repository as the snapshot source; delete deprecated and/or removed software artifact snapshot repositories; validates and corrects existing software artifact snapshot repositories such that the content of each software artifact snapshot repository matches the corresponding definition file (e.g., by adding and/or deleting one or more software artifact files within the software artifact snapshot repository); and send reporting data to an observability platform.

The artifact snapshot repository reporting module 128 may process reporting data received from the one or more management jobs of the snapshot definition file management module 126, for example, and present the data using a visualization or another analysis tool, as would be apparent to a person of ordinary skill in the art. The artifact snapshot repository reporting module 128 may deliver metrics to an observability platform, such as a number of software artifact snapshot repositories in production; a number of new software artifact snapshot repositories; a number of software artifact snapshot repositories deleted; a number of software artifact snapshot repositories modified; and/or source repositories used in definition files.

It is to be appreciated that this particular arrangement of elements 122, 124, 126 and/or 128 illustrated in the software development system 105 of the FIG. 1 embodiment is presented by way of example only, and alternative arrangements can be used in other embodiments. For example, the functionality associated with the elements 122, 124, 126 and/or 128 in other embodiments can be combined into a single module, or separated across a larger number of modules. As another example, multiple distinct processors can be used to implement different ones of the elements 122, 124, 126 and/or 128 or portions thereof.

In some embodiments, the software development system 105 and/or the artifact management engine 120 can have at least one associated database 106 configured to store data pertaining to, for example, software code 107 of at least one application, one or more software artifact repositories 108 and one or more artifact snapshot repositories 109. For example, at least a portion of the at least one associated database 106 may correspond to at least one code repository that stores the software code 107. In such an example, the at least one code repository may include different snapshots or versions of the software code 107, at least some of which can correspond to different branches of the software code 107 used for different development environments (e.g., one or more testing environments, one or more staging environments, and/or one or more production environments). The software artifact repositories 108 may comprise one or more software artifacts used by a given software application. The artifact snapshot repositories 109 may comprise the software artifact snapshot repositories produced by the disclosed techniques for managing software artifact snapshot repositories using definition files.

Also, at least a portion of the one or more user devices 102 can also have at least one associated database (not explicitly shown in FIG. 1). As an example, such a database can maintain a particular branch of the software code 107 that is developed in a sandbox environment associated with a given one of the user devices 102, as discussed further below in conjunction with FIG. 3. Any changes associated with that particular branch can then be sent and merged with branches of the software code 107 maintained in the at least one database 106, for example.

An example database 106, such as depicted in the present embodiment, can be implemented using one or more storage systems associated with the software development system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the software development system 105 are one or more input-output devices, which illustratively comprise keyboards, displays or other types of input-output devices in any combination. Such input-output devices can be used, for example, to support one or more user interfaces to the software development system 105, as well as to support communication between software development system 105 and other related systems and devices not explicitly shown.

Additionally, the software development system 105 and/or the artifact management engine 120 in the FIG. 1 embodiment are assumed to be implemented using at least one processing device. Each such processing device generally comprises at least one processor and an associated memory, and implements one or more functional modules for controlling certain features of the software development system 105 and/or the artifact management engine 120.

More particularly, the software development system 105 and/or the artifact management engine 120 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the software development system 105 and/or the artifact management engine 120 to communicate over the network 104 with the user devices 102, and illustratively comprises one or more conventional transceivers.

It is to be understood that the particular set of elements shown in FIG. 1 for software development system 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the software development system 105, the artifact management engine 120 and/or database(s) 106 can be on and/or part of the same processing platform.

FIG. 2 shows an example of a software development lifecycle in an illustrative embodiment. A software development lifecycle is comprised of a number of stages 210 through 250. In the example of FIG. 2, a software development stage 210 comprises generating (e.g., writing) the software code for a given application. A software testing stage 220 tests the application software code. A software release stage 230 comprises delivering the application software code to a repository. A software deployment stage 240 comprises deploying the application software code to a production environment. Finally, a validation and compliance stage 250 comprises the steps to validate a deployment, for example, based at least in part on the needs of a given organization. For example, image security scanning tools may be employed to ensure a quality of the deployed images by comparing them to known vulnerabilities, such as those known vulnerabilities in a catalog of common vulnerabilities and exposures (CVEs).

In one or more embodiments, a pipeline can comprise one or more of the following elements: (i) local development environments (e.g., the computers of individual developers); (ii) a CI server (or a development server); (iii) one or more test servers (e.g., for functional user interface testing of the product); and (iv) a production environment. The pipelines may be defined, for example, in YAML (Yet Another Markup Language) with a set of commands executed in series to perform the necessary activities (e.g., the steps of each pipeline job).

FIG. 3 shows an example of at least portions of the software development lifecycle of FIG. 2 in further detail in an illustrative embodiment. In the FIG. 3 example, a main branch 302 corresponds to software code of at least one software application. A release branch 304 is created based on the main branch 302. For example, the release branch 304 may be created based on development release timelines corresponding to the software application.

One or more developers (e.g., corresponding to user devices 102) create respective personal branches based on the release branch 304, and perform development work using a sandbox environment 306 and a code IDE (integration development environment) 308. Many developers prefer to write software code using such an IDE that allows the software to be developed in any programming language without having to deal with a particular language syntax. Developers may have multiple IDEs available for application development but there is currently no IDE available for writing software deployment pipeline code.

Developers can commit the changes made in their personal branches to the release branch 304. In the FIG. 3 example, a non-production deployment pipeline 312 is triggered according to one or more specified schedules. The non-production deployment pipeline 312 deploys any changes resulting from the change requests to one or more non-production environments 314.

In some examples, the non-production environments 314 may include one or more of: a developer integration testing (DIT) environment, a system integration testing (SIT) environment, and a global environment. As noted above, the non-production deployment pipeline 312 may be triggered according to schedules defined for each of the non-production environments 314 (e.g., a first schedule for a DIT environment and a second schedule for an SIT environment).

A production deployment pipeline 318 can be triggered when the release branch 304 of the application is ready to be deployed to a production environment 322. Generally, the production deployment pipeline 318 collects any changes that were made to the release branch 304, creates a deployment package, and deploys the package to the production environment 322.

FIG. 4 illustrates a representative definition file 400 for a software artifact snapshot repository associated with a given software application, in accordance with an illustrative embodiment. In one or more embodiments, users of the disclosed software artifact snapshot repository management techniques may update a specified repository to add a definition file, such as definition file 400. The format of the definition file 400 may be a YAML format or a JSON (JavaScript Object Notation) format.

In the example of FIG. 4 the definition file 400 comprises the following fields: org_prefix, name, protocol and artifacts (e.g., open source packages), where “org_prefix” indicates a name of the organization using (or owning) the definition file (e.g., organization A may be a technical operations organization); “name” indicates a base name given to the software artifact snapshot repository; “protocol” indicates the protocol used to access the software artifact snapshot repository; and “artifacts” comprises a list of source artifacts that will appear in the software artifact snapshot repository.

In at least some embodiments, the provided “org_prefix” name value is incorporated in the name of the software artifact snapshot repository. For example, the representative definition file 400 of FIG. 4 may create a software artifact snapshot repository named “organizationA-rpm-myproject-v1.1” comprising only the provided list of artifact files (e.g., stored directly in the created software artifact snapshot repository or referenced in the software artifact snapshot repository using pointers, for example).

In some embodiments, the definition file 400 may also comprise a “delete” field having a binary value indicating whether or not the corresponding software artifact snapshot repository (and optionally, the definition file itself) are to be deleted (or alternatively, the corresponding software artifact snapshot repository and/or the definition file itself may be manually deleted).

The list artifacts in the definition file 400 for the software artifact snapshot repository may be configured by a group defining the software artifact snapshot repository or may be generated automatically, for example, by identifying one or more software artifacts associated with a given software application at a given point in time.

In one or more embodiments, one or more software artifact snapshot repositories belonging to the specified “org_prefix” name value that are not defined in the definition file 400 may be removed. For each defined software artifact snapshot repository, any artifact files that are in the existing software artifact snapshot repository, that are not listed in the definition file 400 will be removed from the software artifact snapshot repository (e.g., all software artifact snapshot repositories specified in the definition file 400 will be synchronized to comprise the exact list of files specified in the definition file 400). All software artifact snapshot repositories specified in the definition file 400, that do not exist, will be created, as discussed further below in conjunction with FIG. 5.

Jenkins automation may be employed in some embodiments to forward data about the software artifact snapshot repositories, the definition files and/or the results of management activities related to the software artifact snapshot repositories and/or definition files to an observability platform (e.g., where a dashboard may visualize the health and usage statistics for the software artifact snapshot repositories, as discussed above).

FIG. 5 is a flow chart illustrating an exemplary processing of git-based pull requests and an initiation of a creation of a software artifact snapshot repository, in accordance with an illustrative embodiment. In the example of FIG. 5, a git-based pull request to merge a definition file into the production branch is received in step 505. In step 510, the snapshot definition file evaluation module 124 validates the syntax of the definition file being merged.

A test is performed in step 530 to determine if the validation of the syntax of the definition file was successful. If it is determined in step 530 that the validation of the syntax of the definition file was not successful, then an updating of the definition file may be performed up to N times in step 535, with program control returning to step 510 to revalidate the syntax of the definition file. If the validation of the syntax of the definition file is not successful after the N attempts, then program control terminates.

If it is determined in step 530 that the validation of the syntax of the definition file was successful, then a test is performed in step 540 to determine if a pull request merge event is detected. If it is determined in step 540 that a pull request merge event is not detected, then program control returns to continue monitoring for the pull request merge event.

If it is determined in step 540 that a pull request merge event is detected, then a management job, discussed further below in conjunction with FIG. 6, is executed in step 560 to process the validated snapshot definition file.

FIG. 6 illustrates a management job 600 for processing updates to a definition file for a software artifact snapshot repository, in accordance with an illustrative embodiment. As discussed above in conjunction with FIG. 5, the management job 600 may run after a merge event has occurred and will read in all changed definition files. For example, any new definition files created since the previous execution of the management job 600 will be read and the corresponding new software artifact snapshot repositories will be created, following verification that the specified software artifact snapshot repository does not already exist. If a given repository definition file has a delete value set to “true,” for example, the specified software artifact snapshot repository will be deleted, and the file will be removed from the production branch.

In the example of FIG. 6, for any changed (e.g., new) definition files, the management job 600 creates a new software artifact snapshot repository using the repository name specified in the corresponding definition file and the artifact sources defined in the artifacts section in the corresponding definition file. In addition, any deprecated and/or removed software artifact snapshot repositories will be deleted. Reporting data metrics are optionally sent to the artifact snapshot repository reporting module.

FIG. 7 illustrates a management job 700 for validating definition files for software artifact snapshot repositories over time, in accordance with an illustrative embodiment. Generally, definition files may be validated against the live configuration of the specified software artifact snapshot repository, and any software artifact snapshot repository that does not match the corresponding definition file will be modified to match the configuration specified in the definition file.

In the example of FIG. 7, in response to an occurrence of a time-based event, for example, the management job 700 validates and corrects existing software artifact snapshot repositories such that the content of each software artifact snapshot repository matches the current corresponding definition file (e.g., by adding and/or deleting software artifacts or other files within the respective software artifact snapshot repository). In addition, reporting data metrics are optionally sent to the artifact snapshot repository reporting module.

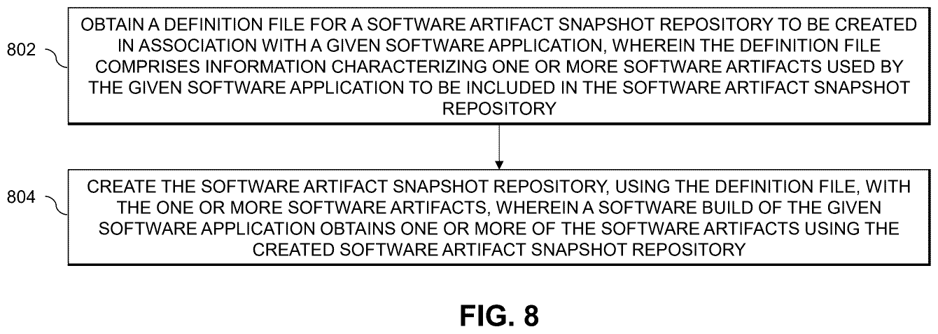

FIG. 8 is a flow diagram illustrating an exemplary implementation of a process for managing software artifact snapshot repositories using definition files, in accordance with an illustrative embodiment. In the example of FIG. 8, a definition file for a software artifact snapshot repository to be created in association with a given software application is obtained in step 802, wherein the definition file comprises information characterizing one or more software artifacts used by the given software application to be included in the software artifact snapshot repository. As used herein, with respect to software artifacts, the phrase “included in the software artifact snapshot repository,” shall be broadly construed to encompass software artifacts that are stored directly in a software artifact snapshot repository as well as software artifacts used by the given software application that are stored in a different repository, where the software artifact snapshot repository references (or points) to a repository location where the respective software artifacts are stored, as would be apparent to a person of ordinary skill in the art.

In step 804, the process of FIG. 8 creates the software artifact snapshot repository, using the definition file, with the one or more software artifacts, wherein a software build of the given software application obtains one or more of the software artifacts using the created software artifact snapshot repository. The term “software build,” as used herein, shall be broadly construed to encompass any operation or process that transforms (e.g., compiles) source code (or other software) into binary files, executable files, and/or other artifacts, as would be apparent to a person of ordinary skill in the art.

In one or more embodiments, the definition file further comprises information characterizing one or more of a protocol associated with the software artifact snapshot repository and naming information associated with the software artifact snapshot repository. The created software artifact snapshot repository may be named using the naming information specified in the definition file.

In some embodiments, the process of FIG. 8 may further comprise, in response to determining that a content of the software artifact snapshot repository does not match a current version of the definition file, automatically updating at least one of the one or more software artifacts included in the software artifact snapshot repository. The automatically updating may comprise deleting one or more software artifact snapshot repositories that have been marked for removal in the respective definition file. The automatically updating may comprise one or more of adding and removing at least one software artifact in the software artifact snapshot repository based at least in part on one or more updates to the definition file.

In at least one embodiment, the definition file for the software artifact snapshot repository is processed to create the software artifact snapshot repository in response to a merge event that merges the definition file with a production branch of the given software application. The information in the definition file characterizing the one or more software artifacts to be included in the software artifact snapshot repository may be automatically obtained by identifying one or more software artifacts associated with the given software application at a given point in time. The process of FIG. 8 may further comprise initiating at least one automated action using the created software artifact snapshot repository (e.g., using the created software artifact snapshot repository to obtain one or more of the software artifacts and/or validating the created software artifact snapshot repository over time using the corresponding definition file).

The particular processing operations and other network functionality described in conjunction with the flow diagrams of FIGS. 2, 3 and 5 through 8, for example, are presented by way of illustrative example only, and should not be construed as limiting the scope of the disclosure in any way. Alternative embodiments can use other types of processing operations to provide functionality for managing software artifact snapshot repositories using definition files. For example, the ordering of the process steps may be varied in other embodiments, or certain steps may be performed concurrently with one another rather than serially. In one aspect, the process can skip one or more of the actions. In other aspects, one or more of the actions are performed simultaneously. In some aspects, additional actions can be performed.

Among other benefits, the disclosed techniques for managing software artifact snapshot repositories using definition files provide software artifact snapshot repositories that maintain the integrity and static content of software build dependency artifact repositories. The disclosed software artifact snapshot repository management techniques significantly reduce the time and effort required to create and maintain software artifact snapshot repositories by automating numerous steps and applies a standard-based methodology to ensure that the software artifact snapshot repositories are managed appropriately. In addition, the software artifact snapshot repositories may be centrally managed using automation, and the overhead is reduced for creating, deleting and/or updating such software artifact snapshot repositories, with traceability, observability, and accuracy.

It should also be understood that the disclosed techniques for managing software artifact snapshot repositories using definition files can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for managing software artifact snapshot repositories using definition files may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although it is to be appreciated that numerous other cloud infrastructure arrangements could be used.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based software artifact snapshot repository management engine, or portions thereof, are illustratively implemented for use by tenants of such a multi-tenant environment.

Cloud infrastructure as disclosed herein can include cloud-based systems. Virtual machines provided in such systems can be used to implement at least portions of a software artifact snapshot repository management platform in illustrative embodiments. The cloud-based systems can include object stores.

In some embodiments, the cloud infrastructure additionally or alternatively comprises a plurality of containers implemented using container host devices. The containers may run on virtual machines in a multi-tenant environment, although other arrangements are possible. The containers may be utilized to implement a variety of different types of functionalities within the storage devices. For example, containers can be used to implement respective processing devices providing compute services of a cloud-based system. Again, containers may be used in combination with other virtualization infrastructure such as virtual machines implemented using a hypervisor.

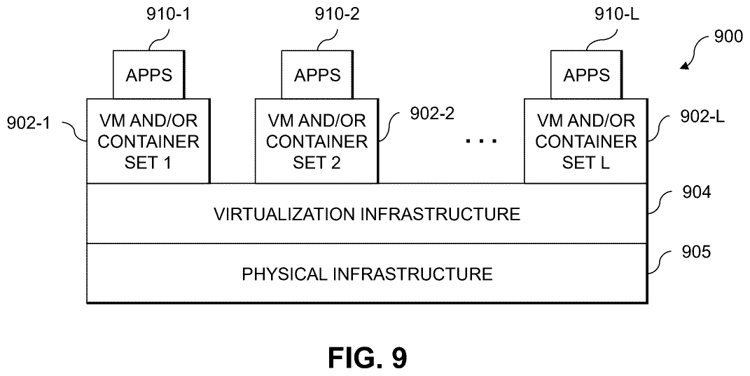

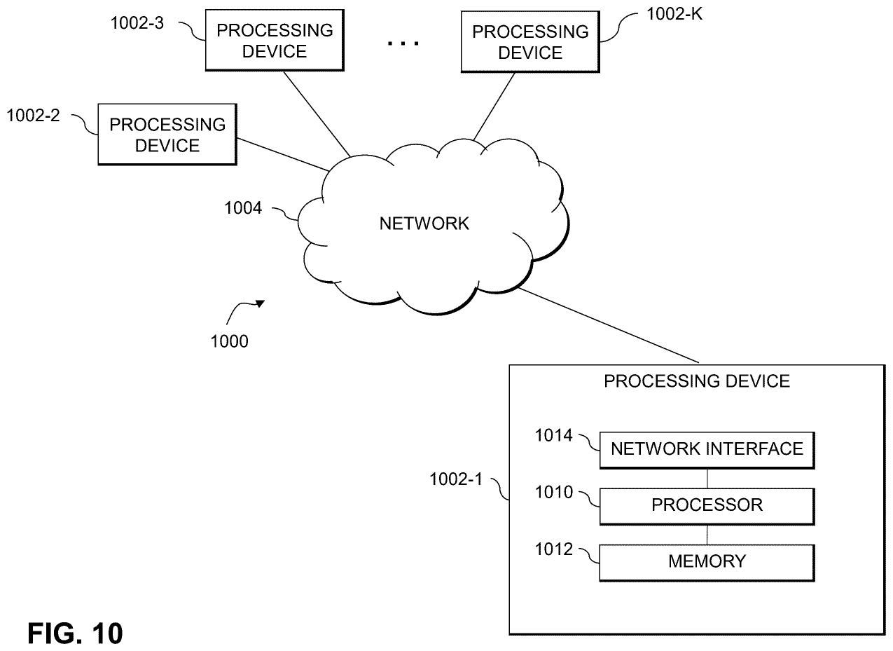

Illustrative embodiments of processing platforms will now be described in greater detail with reference to FIGS. 9 and 10. These platforms may also be used to implement at least portions of other information processing systems in other embodiments.

FIG. 9 shows an example processing platform comprising cloud infrastructure 900. The cloud infrastructure 900 comprises a combination of physical and virtual processing resources that may be utilized to implement at least a portion of an information processing system. The cloud infrastructure 900 comprises multiple VMs and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 may comprise respective VMs, respective sets of one or more containers, or respective sets of one or more containers running in VMs.

In some implementations of the FIG. 9 embodiment, the VMs/container sets 902 comprise respective VMs implemented using virtualization infrastructure 904 that comprises at least one hypervisor. Such implementations can provide software artifact snapshot repository management functionality of the type described above for one or more processes running on a given one of the VMs. For example, each of the VMs can implement software artifact snapshot repository management control logic and associated functionality for maintaining a content of each software artifact snapshot repository to match the current corresponding definition file.

An example of a hypervisor platform that may be used to implement a hypervisor within the virtualization infrastructure 904 is a compute virtualization platform which may have an associated virtual infrastructure management system such as server management software. The underlying physical machines may comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for containers running on bare metal hosts, or containers running on VMs. The containers are illustratively implemented using respective kernel control groups of the operating system. Such implementations can provide software artifact snapshot repository management functionality of the type described above for one or more processes running on different ones of the containers. For example, a container host device supporting multiple containers of one or more container sets can implement one or more instances of software artifact snapshot repository management control logic and associated functionality for maintaining a content of each software artifact snapshot repository to match the current corresponding definition file.

As is apparent from the above, one or more of the processing modules or other components of system may each run on a computer, server, storage device or other processing platform element. A given such element may be viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises at least a portion of the given system and includes a plurality of processing devices, denoted 1002-1, 1002-2, 1002-3, . . . 1002-K, which communicate with one another over a network 1004. The network 1004 may comprise any type of network, such as a WAN, a LAN, a satellite network, a telephone or cable network, a cellular network, a wireless network such as WiFi or WiMAX, or various portions or combinations of these and other types of networks.

The processing device 1002-1 in the processing platform 1000 comprises a processor 1010 coupled to a memory 1012. The processor 1010 may comprise a microprocessor, a microcontroller, an ASIC, an FPGA or other type of processing circuitry, as well as portions or combinations of such circuitry elements, and the memory 1012, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 9 or 10, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide containers.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining a definition file for a software artifact snapshot repository to be created in association with a given software application, wherein the definition file comprises information characterizing one or more software artifacts used by the given software application to be included in the software artifact snapshot repository; and
creating the software artifact snapshot repository, using the definition file, with the one or more software artifacts, wherein a software build of the given software application obtains one or more of the software artifacts using the created software artifact snapshot repository;
wherein the method is performed by at least one processing device comprising a processor coupled to a memory.

2. The method of claim 1, wherein the definition file further comprises information characterizing one or more of a protocol associated with the software artifact snapshot repository and naming information associated with the software artifact snapshot repository.

3. The method of claim 2, wherein the created software artifact snapshot repository is named using the naming information specified in the definition file.

4. The method of claim 1, further comprising, in response to determining that a content of the software artifact snapshot repository does not match a current version of the definition file, automatically updating at least one of the one or more software artifacts included in the software artifact snapshot repository.

5. The method of claim 4, wherein the automatically updating comprises deleting one or more software artifact snapshot repositories that have been marked for removal in the respective definition file.

6. The method of claim 4, wherein the automatically updating comprises one or more of adding and removing at least one software artifact in the software artifact snapshot repository based at least in part on one or more updates to the definition file.

7. The method of claim 1, wherein the definition file for the software artifact snapshot repository is processed to create the software artifact snapshot repository in response to a merge event that merges the definition file with a production branch of the given software application.

8. The method of claim 1, wherein the information in the definition file characterizing the one or more software artifacts to be included in the software artifact snapshot repository is automatically obtained by identifying one or more software artifacts associated with the given software application at a given point in time.

9. The method of claim 1, further comprising initiating at least one automated action using the created software artifact snapshot repository.

10. An apparatus comprising:
at least one processing device comprising a processor coupled to a memory;
the at least one processing device being configured to implement the following steps:
obtaining a definition file for a software artifact snapshot repository to be created in association with a given software application, wherein the definition file comprises information characterizing one or more software artifacts used by the given software application to be included in the software artifact snapshot repository; and
creating the software artifact snapshot repository, using the definition file, with the one or more software artifacts, wherein a software build of the given software application obtains one or more of the software artifacts using the created software artifact snapshot repository.

11. The apparatus of claim 10, wherein the definition file further comprises information characterizing one or more of a protocol associated with the software artifact snapshot repository and naming information associated with the software artifact snapshot repository, and wherein the created software artifact snapshot repository is named using the naming information specified in the definition file.

12. The apparatus of claim 10, further comprising, in response to determining that a content of the software artifact snapshot repository does not match a current version of the definition file, automatically updating at least one of the one or more software artifacts included in the software artifact snapshot repository.

13. The apparatus of claim 10, wherein the definition file for the software artifact snapshot repository is processed to create the software artifact snapshot repository in response to a merge event that merges the definition file with a production branch of the given software application.

14. The apparatus of claim 10, wherein the information in the definition file characterizing the one or more software artifacts to be included in the software artifact snapshot repository is automatically obtained by identifying one or more software artifacts associated with the given software application at a given point in time.

15. The apparatus of claim 10, further comprising initiating at least one automated action using the created software artifact snapshot repository.

16. A non-transitory processor-readable storage medium having stored therein program code of one or more software programs, wherein the program code when executed by at least one processing device causes the at least one processing device to perform the following steps:
obtaining a definition file for a software artifact snapshot repository to be created in association with a given software application, wherein the definition file comprises information characterizing one or more software artifacts used by the given software application to be included in the software artifact snapshot repository; and
creating the software artifact snapshot repository, using the definition file, with the one or more software artifacts, wherein a software build of the given software application obtains one or more of the software artifacts using the created software artifact snapshot repository.

17. The non-transitory processor-readable storage medium of claim 10, wherein the definition file further comprises information characterizing one or more of a protocol associated with the software artifact snapshot repository and naming information associated with the software artifact snapshot repository, and wherein the created software artifact snapshot repository is named using the naming information specified in the definition file.

18. The non-transitory processor-readable storage medium of claim 10, further comprising, in response to determining that a content of the software artifact snapshot repository does not match a current version of the definition file, automatically updating at least one of the one or more software artifacts included in the software artifact snapshot repository.

19. The non-transitory processor-readable storage medium of claim 10, wherein the definition file for the software artifact snapshot repository is processed to create the software artifact snapshot repository in response to a merge event that merges the definition file with a production branch of the given software application.

20. The non-transitory processor-readable storage medium of claim 10, wherein the information in the definition file characterizing the one or more software artifacts to be included in the software artifact snapshot repository is automatically obtained by identifying one or more software artifacts associated with the given software application at a given point in time.
